(19) United States
(12) Patent Application Publication
(10) Pub. No.: US 2018/0276266 A1
(43) Pub. Date: Sep. 27, 2018

(54) CORRELATING END NODE LOG DATA WITH CONNECTIVITY INFRASTRUCTURE PERFORMANCE DATA

(71) Applicant: CA, Inc., New York, NY (US)

(72) Inventor: Kiran Prakash Diwakar, Pune (IN)

(21) Appl. No.: 15/470,579

(22) Filed: Mar. 27, 2017

(51) Int. Cl. G06F 17/30; H04L 12/24; G06F 11/34; H04L 12/26; H04L 29/06

(52) U.S. Cl. CPC G06F 17/30368; H04L 41/0213; G06F 11/3476; H04L 69/08; G06F 17/3053; H04L 43/0811; H04L 41/0681; G06F 17/30525

(57) ABSTRACT

Techniques for correlating end node data with connectivity infrastructure and selectively accessing end node log data are disclosed. In some embodiments, operational events are detected for target system entities that include connectivity entities and end node entities. For each of the detected operational events, an event record is generated that includes an entity identifier (ID) and a metric type. The entity IDs and the metric types included in the event records are utilized to correlate two or more of the event records. A determination is performed of whether each of the entity IDs in the correlated event records corresponds to a connectivity entity or an end node entity. Log requests are generated and sent to each of the target system entities having an entity ID in a correlated event record that corresponds to an end node entity.

### BACKGROUND

The disclosure generally relates to the field of data processing, and more particularly to data analytics and presentation that may be utilized for higher level operations.

Networked systems comprise intermediary nodes (e.g., routers and switches) that collectively provide a connectivity infrastructure between and among end nodes. The intermediary nodes may include components within end nodes such as NICs as well as standalone devices such as switches and routers. “Network components” include hardware and software systems, devices, and components that implement network connectivity and may therefore include a NIC within an end node. System monitoring may be utilized for fault detection within large networked systems. Within a given network system, differing computing architectures and limited on-device computing resources on some end nodes such as Internet of Things (IoT) sensor nodes presents efficiency issues for identifying the source of a given system event.

### BRIEF DESCRIPTION OF THE DRAWINGS

Aspects of the disclosure may be better understood by referencing the accompanying drawings.

FIG. 1 is a block diagram illustrating a networking environment that includes a cross-domain monitoring system in accordance with some embodiments;

FIG. 2 is a block diagram depicting a cross-domain monitoring architecture that includes multiple service domains in accordance with some embodiments;

FIG. 3 is a block diagram illustrating a system that utilizes cross-domain event correlation to retrieve and render log analytics data in accordance with some embodiments;

FIG. 4 depicts a monitoring console in which a management client displays event message objects and a network topology object that displayably indicates a determined end node operating condition corresponding to one of the event message objects;

FIG. 5 is a flow diagram illustrating operations and functions for selectively retrieving and rendering end node log data in accordance with some embodiments;

FIG. 6 is a flow diagram depicting operations and functions for correlating event record data in accordance with some embodiments; and

FIG. 7 is a block diagram depicting an example computer system that implements cross-domain correlation and end node log rendering in accordance with some embodiments.

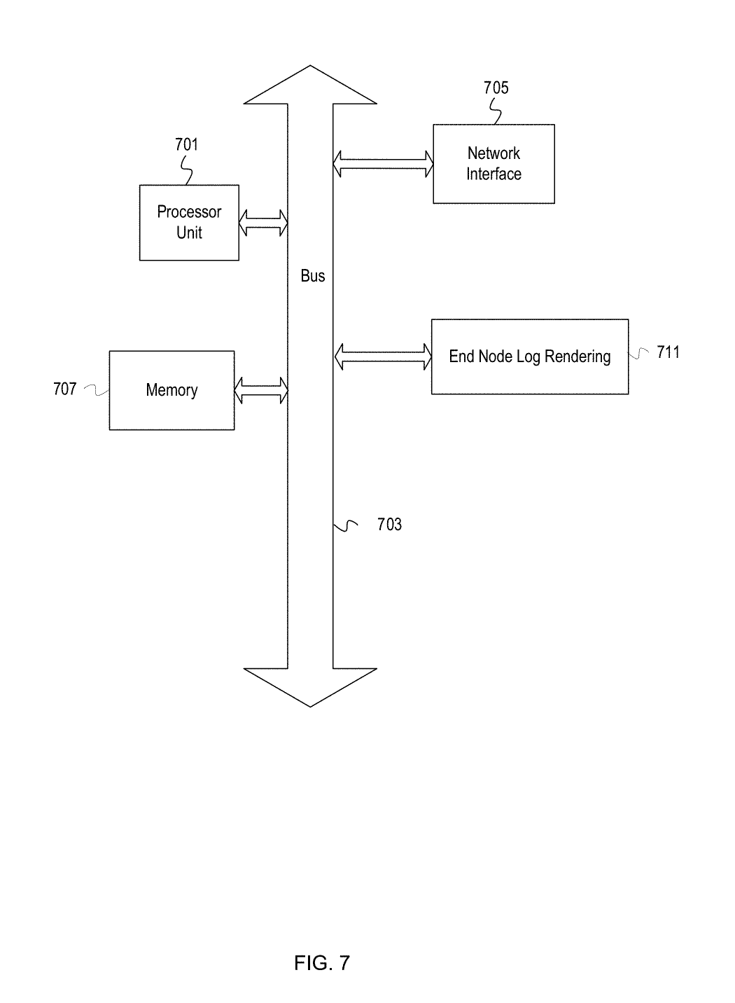

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Overview

A monitoring system may be characterized as comprising software components that perform some type of utility function, such as performance and/or fault monitoring, with respect to an underlying target system. A “target system” may be characterized as a system configured, using any combination of coded software, firmware, and/or hardware, to perform user processing and/or network functions. For example, a target system may include a local area network (LAN) comprising target system components such as network connectivity devices such as routers and switches as well as end-nodes such as host computer devices. A monitoring system may be deployed to perform performance support utility tasks such as performance monitoring and fault detection and remediation functions performed by fault management systems. A monitoring system typically employs operational/communication protocols distinct from those employed by the target system components. For example, many fault management systems may utilize some version of the Simple Network Management Protocol (SNMP).

A cross-domain monitoring system may be generally characterized as comprising a log management host that collects performance and configuration information from multiple service domain hosts that each service a respective independent service domain. Each of the service domain hosts communicate with respective management clients that may also communicate with the log management host. Management clients include presentation tools that include graphical user interfaces (GUIs) configured to display objects associated with respective software and hardware monitoring/management applications.

The monitoring/management scope of each service domain may or may not overlap the domain coverage of other service domains. Given multiple non-overlapping or partially overlapping service/monitoring domains and variations in the type and formatting of collected information in addition to the massive volume of the collected information, it is difficult to efficiently render performance information across service domains while enabling efficient root cause analysis in the context of a detected problem.

Embodiments described herein include components and implement operations and functions for collecting application log data from target systems within a number of mutually distinct service domains. Embodiments may utilize performance metric data that is collected in the course of system monitoring/management to locate and retrieve log data that is native to application programs within the target system. The application log data may be processed in association with the performance metric data utilized to obtain the application log data. For example, the application log data may be displayed in a log view window that displayably correlates (e.g., color coding) events recorded in the log data with a metric object that displays a target system entity and performance metric associated with an event.

System performance data for specified sets of target system entities are collected by and within each of multiple service domains. Each of the service domains is defined, in part, by the “target system” that it is configured to monitor and manage. For example, a target system may comprise network devices (e.g., routers, switches) within a network or a set of application program instances distributed across client nodes. The subsystems, devices, and components constituting a target system may include software, firmware, and/or hardware entities such as program instruction modules. The functional portion of a services domain includes monitoring components such as agents and/or agentless performance data collection mechanisms that detect, measure, or otherwise determine and report performance data for the target system entities. The service agents or agentless mechanisms deployed within each of the service domains are coordinated by a service domain host that further records the performance data in a service domain specific dataset, such as a database and/or performance data logs. In this manner, each service domain constitutes a management system that is functionally extrinsic to the operations of the target system and comprises a monitoring host and operationally related monitoring components (e.g., service agents). The service domain of the management system is further defined, in part, by a specified set of target system entities that the monitoring components are configured to collect performance metric data for.

Each of the management systems may be characterized as including software components that perform some type of utility function, such as performance monitoring, with respect to an underlying service domain of target system entities (referred to herein alternatively as a “target system” or a “system”). A target system may be characterized as a system configured, using any combination of coded software, firmware, and/or hardware, to perform user processing and/or network functions. For example, a target system may include a local area network (LAN) comprising network connectivity components such as routers and switches as well as end-nodes such as host and client computer devices.

In cooperation with service agents or agentless collection probes distributed throughout a target system (e.g., a network), a service domain host acquires performance metric data such as time series metrics for system entities. The performance metric data may include time series metrics collected in accordance with collection profiles that are configured and updated by the respective management system. The collection profiles may be configured based, in part, on specified relations (e.g., parent-child) between the components (e.g., server-CPU) that are discovered by the management system itself. In some embodiments, the collection profiles may be configured to include log data that are natively generated by application programs (application servers and application client instances). Such log data may be referred to herein in a variety of manners such as application log data, event logs, etc.

The event information and other data included in application log data is distinct from the performance metric data collected and recorded by service domain monitoring components in terms of the collection agent. Performance metric data is collected and recorded by monitoring components that are functionally extrinsic to the operation of the target system entities that are being monitored. In contrast, application log data that may be recorded in application event logs is collected (e.g., detected, determined) and recorded by a portion of the native application program code.

Example Illustrations

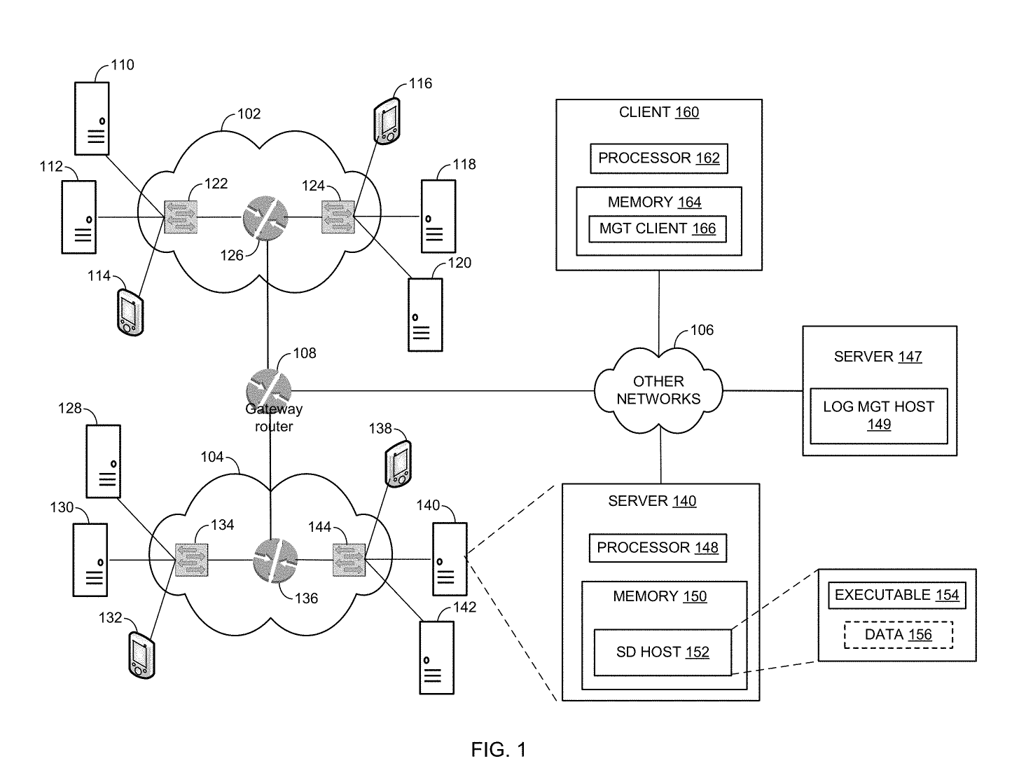

FIG. 1 is a block diagram depicting a network environment that implements a heterogeneous monitoring system in accordance with some embodiments. The network environment includes multiple networked devices configured into a pair of subnets 102 and 104. As utilized herein, a subnet may be characterized as a programmatically/logically distinguishable subdivision of a larger network. Subnet 102 comprises network connectivity devices such as a router 126 and switches 122 and 124. Router 126 and switches 122 and 124 provide OSI layer 3 (routing) and layer 2 (switching) connectivity among multiple end-point devices, or “end-nodes.” As shown the end nodes include end nodes 110, 112, and 114 that are logically connected by switch 122 to router 126. The end nodes further include end nodes 116, 118, and 120 that are logically connected by switch 124 to router 126. Subnet 104 comprises network connectivity devices such as a router 136 and switches 134 and 144. Router 136 and switches 134 and 144 provide OSI layer 3 and layer 2 connectivity among multiple end-nodes including end node devices 128, 130, and 132 that are logically connected by switch 134 to router 136, and end nodes 138, 140, and 142 that are logically connected by switch 144 to router 136. As utilized herein, an entity (e.g., a node, device, component, etc.) described as being a “connectivity” entity generally refers to a characteristic function of the entity as an intermediate hardware and/or program code entity that “routes” (includes switching and broadcasting) information signal that originated at a source end node and will ultimately be processed at an application layer by one or more destination end nodes.

In the depicted embodiment, network connectivity devices and end nodes are configured within the respective subnets 102 and 104 based, at least in part, on a network address format used by a network addressing protocol. For example, Internet Protocol (IP) network routing may be utilized by the network devices/components including network interfaces used by each of the connectivity and end nodes (e.g., network interface controllers). In this case, subnets 102 and 104 may be configured based on an IP network address format in which a specified fixed-bit prefix specifies the subnet ID and the remaining bits form the device-specific address.

The end-point and connectivity devices within subnets 102 and 104 are mutually interconnected via a gateway router 108. The end nodes (e.g., end node 114) may be portable wireless computing devices such as a smartphone or a tablet computer. Others of the end-nodes may comprise any combination of computer terminals from which applications, network clients, network servers, and other type of application and system programs may be executed. For example, one or of the end nodes may include application specific nodes such as automated teller machines (ATMs). While the logical and/or physical network connectivity between the subnets and among the subnet devices is expressly illustrated (as connecting lines), additional programmatic configurations may be present. For example, two or more of the end-nodes within subnets 102 and/or 104 may execute distributed instances of an application hosted and served by another of the nodes or by an application server coupled to subnets 102 and 104 via gateway router 108 and other networks 106.

The depicted network environment further includes a heterogeneous monitoring system that may comprise any number of devices and components including combinations of coded software, firmware, and/or hardware. The monitoring system is configured to perform a utility management function with respect to the operations of hardware and/or software systems, subsystems, devices, and components executing or otherwise implemented within or across one or more of the target system components. The depicted monitoring system comprises multiple service domain hosts each managing a respective one of multiple service domains. For example, server 140 is depicted as comprising a processor 148 and associated memory 150. A service domain host 152 is deployed within server 140 as other service domain hosts may be deployed within one or more additional of the nodes within subnets 102 and 104.

Service domain host 152 includes executable code 154 and data 156 utilized for performance monitoring and event detection for a specified service domain. The executable code 154 may also include program instructions for configuring the specified service domain as including a number of the connectivity nodes and end-nodes within subnets 102 and 104. In some embodiments, service domain host 152 may utilize SNMP protocol for performing operations and functions related to monitoring performance and detecting faults. In such embodiments, the data 156 may include Management Information Bases (MIBs) maintained for each of the devices/components being monitored or otherwise managed.

The depicting heterogeneous monitoring system further includes a cross-domain log management host 149 deployed from a server platform 147. Log management host 149 is communicatively coupled with the service domain hosts, including service domain host 152, via one or more networks 106. Log management host 149 is configured, using any combination of coded software, firmware, and/or hardware, to collect performance metric data and configuration information from the service domain hosts. Server platform 147 includes network communication components to enable communication of log management host 149 with the devices within subnets 102 and 104 as well as with a client computer 160. Similar to any of the end-nodes within subnets 102 and 104, client computer 160 includes a processor 162 and associated computer memory 162 from which a management client 166 executes. In some embodiments, management client 166 may request and retrieve performance metrics and associated operational event information obtained and stored by any of the service domain hosts and/or log management host 149.

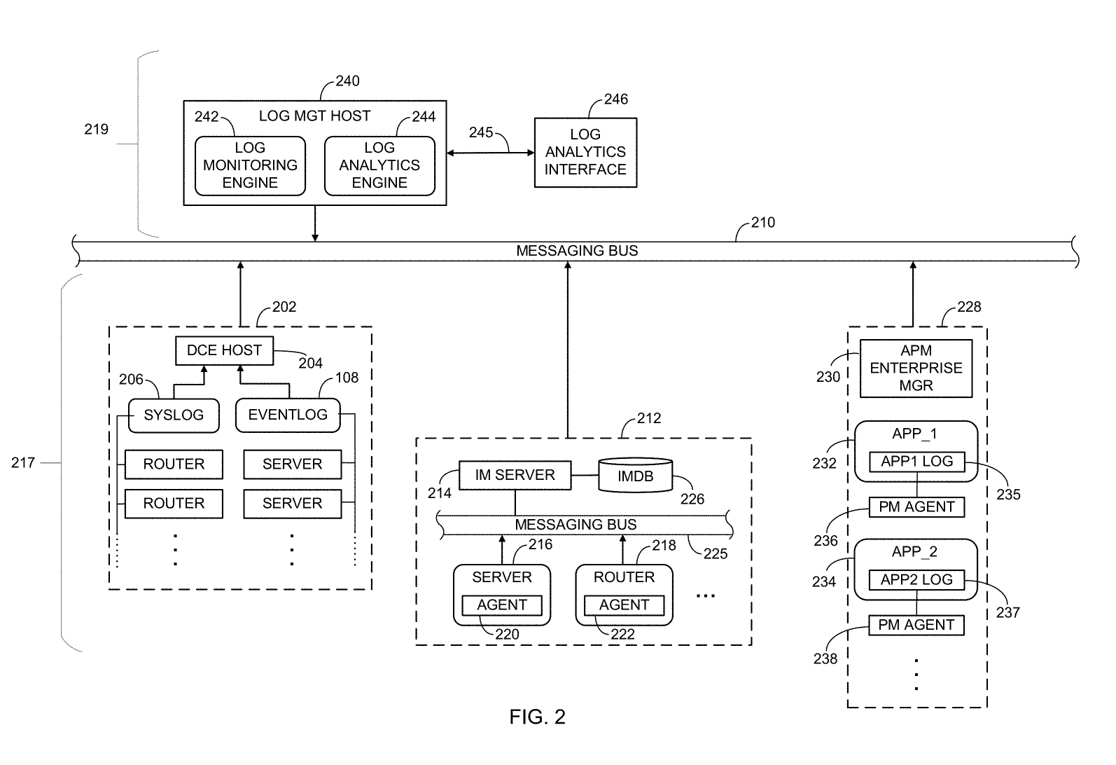

FIG. 2 is a block diagram depicting a cross-domain monitoring system that includes multiple service domains in accordance with some embodiments. The depicted system includes a monitoring infrastructure 217 comprising service domains 202, 212, and 228. The system further includes an analytics infrastructure 219 comprising a log management host 240 and a log analytics interface 246. The components of analytics infrastructure 219 communicate with components of monitoring infrastructure 217 via a messaging bus 210. The analytics information to be presented is derived, at least in part, from operational performance data, including performance metrics and operational events determined based on performance metrics, detected and collected within service domains 202, 212, and 228. Each of the service domains includes a specified (e.g., by monitor system configuration) set of target system entities that may each include combinations of software and/or hardware forming components, devices, subsystems, and systems for performing computing and networking functions. As utilized herein, a “target system entity” generally refers to a hardware or software system, subsystem, device, or component (collectively referred to as “components” for description purposes) that is configured as part of the target system itself, rather than part of the monitoring system that monitors the target system. For instance, service domain 202 includes multiple server entities. The target system entities within service domain 212 also include multiple servers including servers 216 and 218. The target system entities within service domain 228 include application program instances 232 and 234.

As further shown in FIG. 2, each of service domains 202, 212, and 228 further include program components that comprise all or part of a respective management system for the service domain. Such management system components may be configured to perform support utility tasks such as monitoring performance, fault detection, trend analysis, and remediation functions. A management system typically employs operational/communication protocols distinct from those employed by the target system components. For example, many fault management systems may utilize some version of the Simple Network Management Protocol (SNMP). As utilized herein, a “service domain” may be generally characterized as comprising a management system that includes a monitoring host and one or more service agents. The service domain may be further characterized, in part, in terms of the identity of the target system entities that the monitoring components are configured to monitor. For example, a distributed management system may include multiple management system program instances that are hosted by a management system host. In such a case, the corresponding service domain comprises the management system program instances, the management system host, and the target system entities monitored by the instances and host.

The monitoring components within service domain 202 include a syslog unit 206 and an eventlog unit 208. As illustrated, syslog unit 206 collects operational data such as performance metrics and informational data such as configuration and changes on the target systems from messages transacted between syslog unit 206 and a plurality of servers. Similarly, eventlog unit 208 collects operational data such as performance events (e.g., events triggering alarms) and informational data such as configuration and changes on the target systems from agentless communications between eventlog unit 208 and a plurality of servers. A distributed computing environment (DCE) host 204 functions as the monitoring host for service domain 202 and collects the log data from syslog unit 206 and eventlog unit 208. In the foregoing manner, service domain 202 is defined by the system management configuration (i.e., system monitoring configuration of DCE host 204, syslog unit 206, and eventlog unit 208) to include specified target system servers, which in the depicted embodiment may comprise hardware and software systems, subsystems, devices, and components. In some embodiments, syslog unit 206 and eventlog unit 208 may be configured to monitor and detect performance data for application programs, system software (e.g., operating system), and/or hardware devices (e.g., network routers) within service domain 202.

Service domain 212 includes a management system comprising an infrastructure management (IM) server 214 hosting an IM database 226. IM server 214 communicates with multiple collection agents including agents 220 and 222 across a messaging bus 225. Agents 220 and 222, as well as other collection agents not depicted within service domain 212, are configured within service domain 212 to detect, measure, or otherwise determine performance metric values for corresponding target system entities. The determined performance metric data are retrieved/collected by IM server 214 from messaging bus 225, which in some embodiments, may be deployed in a publish/subscribe configuration. The retrieved performance metric data and other information are stored by IM server 214 within a log data store such as IM database 226, which may be a relational or a non-relational database.

The management system components within service domain 228 include an application performance management (APM) enterprise manager 230 that hosts performance management (PM) agents 236 and 238 that are deployed within application instances 232 and 234, respectively. Application instances 232 and 234 may be client applications that are hosted by an application server such as one of servers within services domains 202 and/or 212. Application instances 232 and 234 execute on client stations/devices (not depicted). In some embodiments, application instances 232 and 234 may execute on computing infrastructure including server hardware and operating system platforms that are target system entities such as the servers within service domain 212 and/or service domain 202.

In addition to the monitoring infrastructure 217, the depicted environment includes analytics infrastructure 219 that includes program instructions and other components for efficiently processing and rendering analytics data, including analytics data derived from end node logs. Analytics infrastructure 219 includes log management host 240 that is communicatively coupled via a network connection 245 to log analytics interface 246. As explained in further detail with reference to FIGS. 2-6, log management host 240 is configured using any combination of software, firmware, and hardware to retrieve or otherwise collect performance metric data from each of service domains 202, 212, and 228.

Log management host 240 includes a log monitoring engine 242 that communicates across a messaging bus 210 to poll or otherwise query each of the service domain hosts 204, 214, and 230 for performance metric and operational event data recorded in respective local data stores such as IM database 226. In some embodiments, log management host 240 retrieves the service domain log data in response to client requests delivered via analytics interface 246. Log management host 240 may record the collected service domain log data in a centralized data storage structure such as a relational database (not depicted). The data storage structure may include data tables indexed in accordance with target system entity ID for records corresponding to those retrieved from the service domains. The tables may further include additional indexing mechanisms such as index tables that logically associate performance data between service domains (e.g., index table associating records between service domains 202 and 228).

Log management host 240 further includes a log analytics engine 244 that is configured using program code or other logic design implementation to process the operational event records and other performance metric data collected by log monitoring engine 242. Log analytics engine 244 is further configured to utilize the event record processing to determine the scope of secondary log requests and performance metric data requests from end nodes and connectivity nodes.

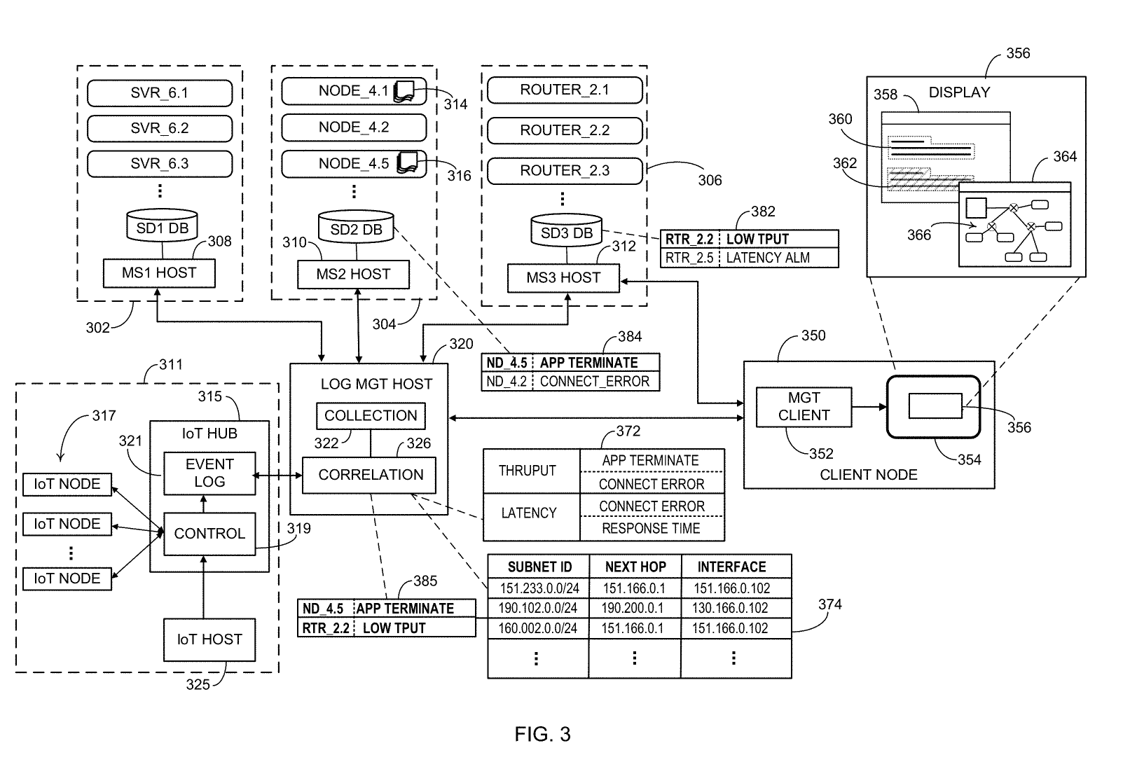

FIG. 3 is a block diagram illustrating a system that utilizes cross-domain event correlation to retrieve and render end node log data in accordance with some embodiments. The system includes a log management host 320 that may include the features of log management hosts 149 and 240 depicted and described with reference to FIGS. 1 and 2. As shown, log management host 320 is communicatively coupled with a client node 350 and with service domains 302, 304, 306, and 311. Log management host 320 is configured, using any combination of software, firmware, and/or hardware, to facilitate real-time, inline processing and rendering of analytics information within client node 350 based on performance information, including data within operational event records, generated from service domain performance metric data.

As shown in FIG. 3, service domains 302, 304, and 306 include respective sets of target system entities. The target system entities within service domain 302 include server platforms, SVR_6.1, SVR_6.2, SVR_6.3 . . . . The target system entities within service domain 304 include end node application instances NODE_4.1, NODE_4.2, NODE_4.5 . . . . The target system entities within service domain 306 include network routers, ROUTER_2.1, ROUTER_2.2, ROUTER_2.3, . . . . While not expressly depicted in FIG. 3, each of service domains 302, 304, and 306 further includes monitoring system components for detecting, measuring, or otherwise determining performance metrics for the respective set of target system entities. As shown in FIG. 2, the monitoring system components may comprise agents or agentless metric collection mechanisms. The performance data, including raw performance metrics and operational events (e.g., fault condition), collected for the target system entities are recorded by service domain hosts 308, 310, and 312 in respective service domain logs SD1, SD2, and SD3.

Service domain 311 includes target devices within a sensor network such has may be implemented in an Internet-of-Things networked system. The target system entities within service domain 311 are included in a sensor network comprising multiple sensor nodes (each labeled “IoT NODE”). The sensor end nodes are each communicatively coupled with an IoT hub 315 that comprises a control unit 319 and an event hub 321. In some embodiments, an IoT host 325 transmits instructions, including configuration and operating instructions, to control unit 319 which configures and/or manages operation of the sensor end nodes accordingly. IoT nodes may include sensors or agents such as those described with reference to FIGS. 1 and 2 for measuring or otherwise detecting performance data for each of the nodes. The performance data may include performance metrics and/or operational event data that is transmitted to and recorded in an event log 321 via control unit 319.

The performance metric data for one or more of service domains 302, 304, 306, and 311 may be accessed by a management client application 352 executing on client node 350. For instance, management client 352 may be a web server client or an application server client that connects to and executes in coordination with one of service domain hosts 308, 310, or 312. Depending on the configuration, management client 352 may request and retrieve performance metric data from the SD1, SD2, or SD3 database based on queries sent by management client 352 to one of the corresponding monitoring hosts. The performance metric data may be retrieved as log records and processed by management client 352 to generate performance metric objects to be displayed on a display device 354. For instance, the performance metric data may be displayed within a window object 356 that includes multiple metric objects. In the depicted example, window object 356 includes an alarm panel 358 that itself includes metric objects 360 and 362. Window object 356 further includes a log analytics object 366 that may be generated in accordance with the operations and functions described with reference to FIGS. 2-6.

The depicted cross-domain analytics system further includes components within log management host 320 that interact with management client 352 as well as service domains 302, 304, 306, and 311 to render end node log data, such as application log data, in conjunction with performance metrics data in a heterogeneous monitoring environment. The application log data may be recorded in application event log records such as event log records 314 and 316. In the depicted embodiment, event log records 314 and 316 are generated by the native program code of end-node application instances NODE_4.1 and NODE_4.5, respectively. While in the depicted embodiment, log management host 320 is depicted as a separate component, one or more components of log management host 320 may be implemented by incorporation as components of management client 352. Log management host 320 may include a collection unit that may be configured, using any combination of coded software, firmware, and/or hardware, to perform the function of log monitoring engine 242 including collecting performance metric data from the service domains. For example, the depicted log management host 320 includes a collection unit 322 that is configured to poll or otherwise request and retrieve performance data, including performance metrics and operational event data such as may be associated with faults or alarms from each of the mutually distinct service domains.

Collection unit 322 may further include program instructions for generating service domain specific records dependently or independently of management client requests. Request for retrieving service domain data may include search index keys such as target system entity IDs and/or performance metric type IDs that are used to access and retrieve the resultant records from the SD1, SD2, and SD3 logs. In addition to program instructions for collecting performance metric data, collection unit 322 includes program instructions for collecting target system configuration data from service domain log records or other records maintained by service domain hosts 308, 310, and 312, and IoT control unit 319. Collection unit 322 associates the collected performance metric data and target system configuration data (collectively, service domain data) with respective service domain identifiers and target system entity identifiers. The service domain data includes sets of performance metric and configuration data for each of the service domains. For example, the performance metric data is represented as respective records for service domains 302, 304, 306, and 311. The target system configuration data may also be represented as records for respective service domains.

The performance data within the service domain data may include various types and combinations of metrics related to the operation performance of target system entities. The performance data may be included in records within a performance metric table. The configuration data portion of the service domain data may include inter-entity connectivity data, inter-entity operational association data, and other types of data that directly or indirectly target system configuration associations among target system entities. For example, log management host 320 includes a network connectivity table 374 that may be generated by and/or accessed by collection unit 322. In some embodiments, the row-wise records within network connectivity table 374 may include network address data collected such as from router tables within one or more networks or subnets that include the end nodes and connectivity nodes monitoring by service domains 302, 304, 306, and 311.

Log management host 320 further includes a correlation unit 326 that is configured to process the entity IDs and metric/event types of two or more event records to determine correlations between and among event records generated by the service domains and/or collection unit 322. In some embodiments, correlation unit 326 compares records between the configuration tables, such as network connectivity table 374, of different service domains to determine and record cross-domain associations between and among target system entities belonging to different service domains. Correlation unit 326 may read network connectivity table 374 individually or in combination with error causation table 327 to correlate events records generated within the service domains.

Correlation unit 326 processes event-based requests from management client 352 to retrieve information that may be utilized to identify operational conditions associated with an event detected by the management client. As part of event-based request processing, correlation unit 326 accesses and processes records within network connectivity table 374 and error causation table 372 in the following manner. In some embodiments, an event may be detected via management client 352 detecting an input graphical selection of a metric object, such as one of metric objects 360 or 362. In response to detecting an event corresponding to a metric object indicating a below threshold throughput value for ROUTER_2.2, management client 352 transmits an event request to log management host 320. The event request specifies the target system entity ID RTR_2.2 and an associated performance metric type, such as “TPUT,” both of which are associated with the detected event such as via being displayed in association within the metric object. The event record data may be obtained by management client 352 from monitoring system host 312, which has generated event records 382 including the first row-wise record that associates router ID “RTR_2.2” with event metric “LOW TPUT.”

In response to the event request, correlation unit 326 utilizes a key corresponding to “LOW TPUT” as an index within error causation table 372 to identify “APP TERMINATE” and “CONNECT_ERROR” as each having a dependency relation with “THRUPUT.” Correlation unit 326 utilized the identified dependency relations in combination with network connectivity information within connectivity table 374 to locate the first row-wise record within event records 384 that associates application end node ND_4.5 with an “APP TERMINATE” fault condition.

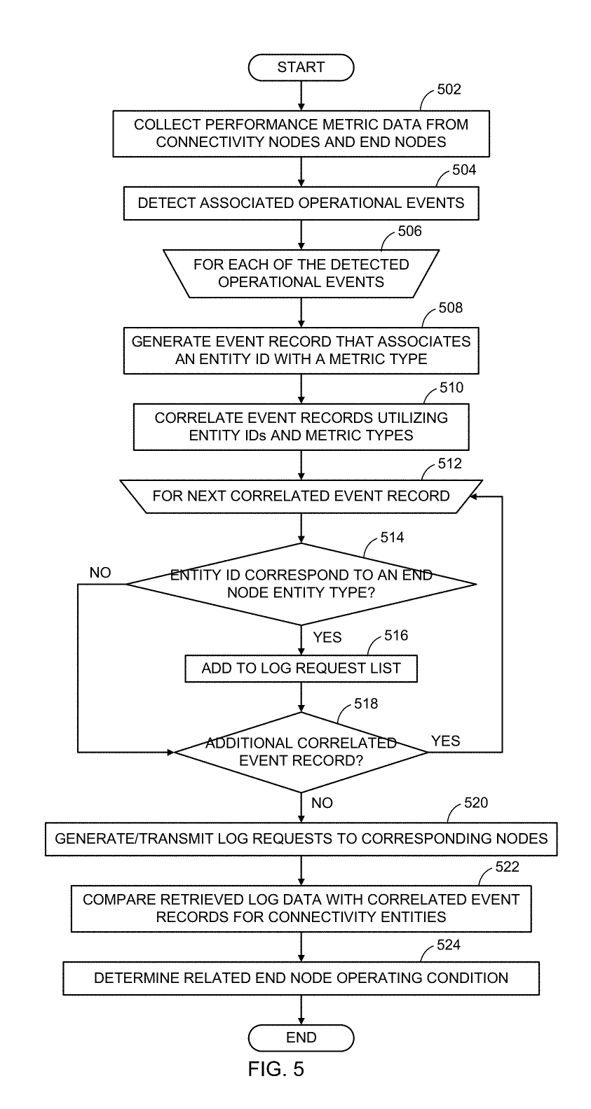

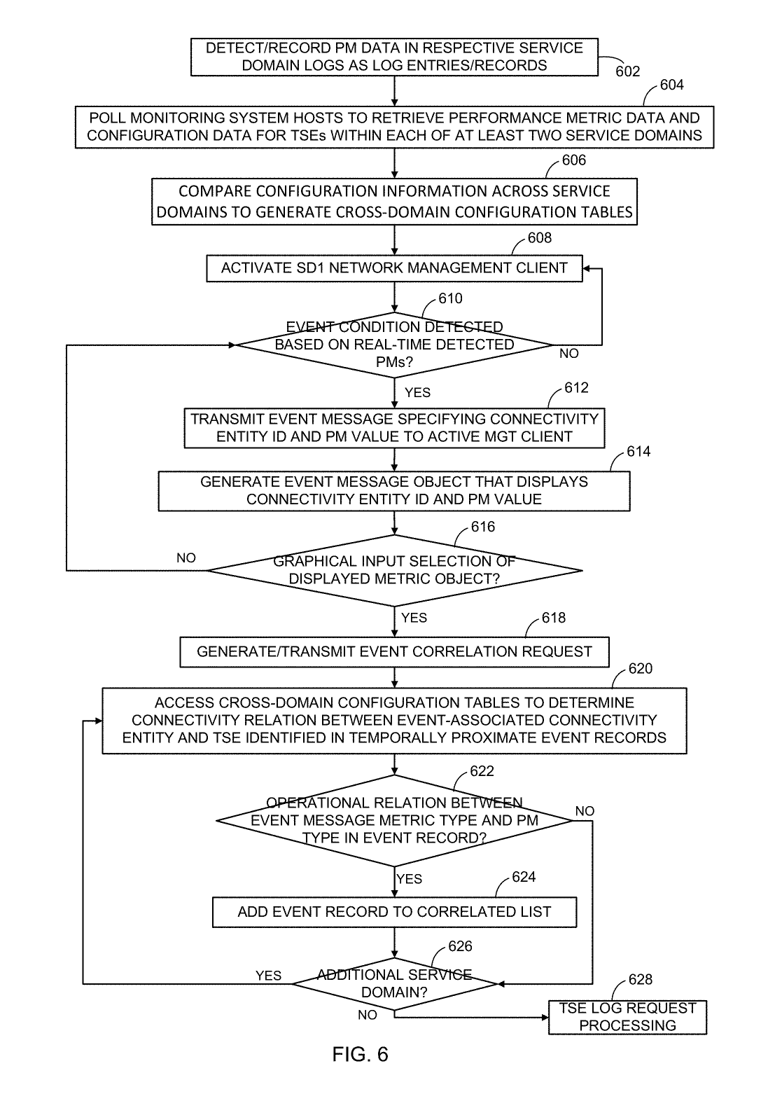

In response, correlation unit 326 generates an event correlation object 385 that associates data from the event record specifying that a low throughput condition has been detected for the router ID RTR_2.2 and the event record specifying that the application ID ND_4.5 has been terminated. As explained in further detail with reference to FIGS. 5 and 6, log management host alone or in combination with management client determines whether entity IDs, RTR_2.2 and ND_4.5, correspond to network connectivity type nodes or end nodes. For example log management host 320 may include code and reference data such as device categorization data that enables determining whether a given device/node ID corresponds to a connectivity type device or an end node type device.

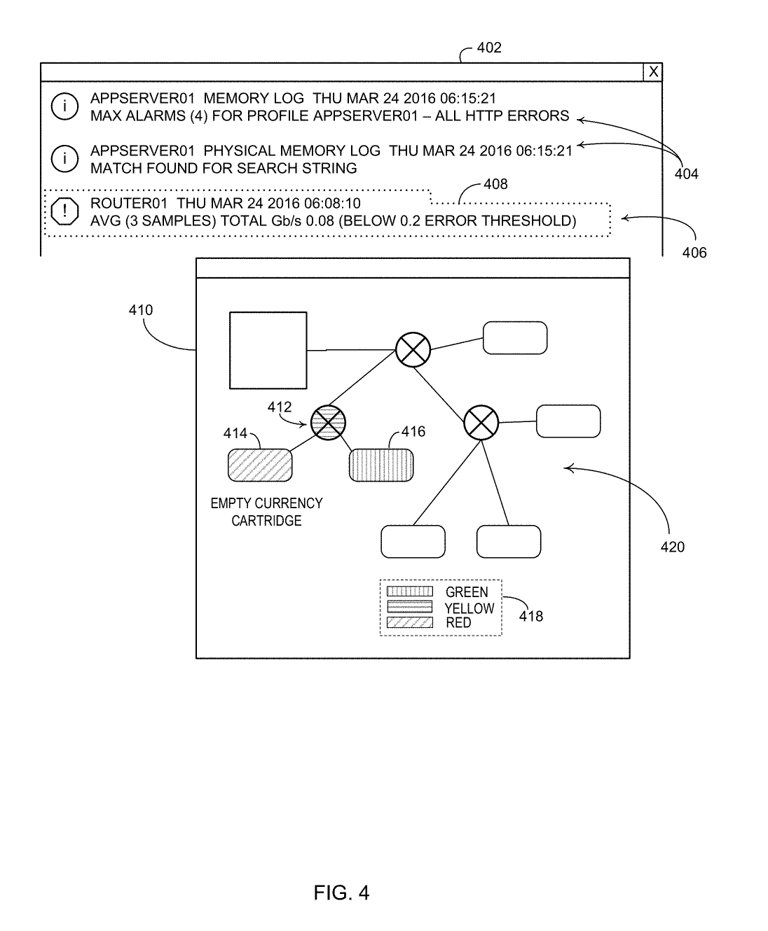

As shown in FIG. 4, an event message object such as either or both event message objects 360 and 362 may comprise a text field specifying a target system entity ID associated with a performance metric value. FIG. 4 depicts an example alarm panel object 302 that includes multiple event message objects. Panel object 302 includes event message objects 304 in the form of monitoring messages indicating operational status of an application server APPSERVER01. Panel object 302 further includes an event message object 306 that specifies a router performance metric value indicating that the throughput of ROUTER01 is at 0.08 Gb/s, below a specified error threshold of 0.2 Mb/s. Referring to FIG. 4 in conjunction with FIG. 3, a management client may respond to graphical input selection of event message object 306 by generating an event request that specifies the target system entity, ROUTER01, and the performance metric type, throughput. The event

Various forms of analytics information may be retrieved based on the event request including end node log data that may be displayably correlated with the triggering event message. A log analytics window 410 may be generated and displayed in response to retrieving application log data in accordance with some embodiments. Log analytics window 320 displays a network topology object 420 comprising multiple network nodes including connectivity nodes and end nodes. Network topology object 420 further includes a legend 418 that associates each of the respectively unique visual indicators (e.g., different colors or other visual identifiers) respectively coded nodes.

FIG. 5 is a flow diagram illustrating operations and functions for correlating end node log data with connectivity infrastructure performance data in accordance with some embodiments. The operations and functions depicted and described with reference to FIG. 5 may be implemented by one of more of the systems, devices, and components illustrated and described with reference to FIGS. 1-4. The process begins as shown at block 502 with service domain hosts possibly in combination with components of a cross-domain log management host detecting and recording performance and event data, such as error/fault data. The log management host detects one or more operational events that are associated with the monitored data (block 504).

Beginning at block 506, the log management host processes each of the detected operational events to generate a list of one or more of the detected event records that are correlated. For a next detected operational event, the log management host generates an event record that associates an entity ID with a metric type (block 508). Next, as shown at block 510, the log management host correlates the generated event records based, at least in part, on the entity IDs and the metric types included in the event records.

Beginning at block 512, the log management host processes each of the correlated event records to determine whether and to which nodes to send end node log requests. For a next correlated event record, the log management node determines whether the entity ID corresponds to an end node entity or a network connectivity entity (block 514). In response to a determination that the entity ID corresponds to an end node entity type, control passes to block 516 with the entity ID being included in a log request list. If the entity ID is determined not to correspond to an end node, such as if the entity ID is determined to correspond to a network connectivity entity, control passes to block 518 with processing of a next event record in the set of correlated records.

Following processing of the correlated event records, the log management host or a management client node generates and transmits log requests to each of the target system entities having an entity ID in a correlated event record that corresponds to an end node entity (block 520). The log management host or the management client receives log data from the target system entities to which the log requests are sent. At block 522, the log management host or management client compares the log data with correlated event records for target system entities having entity IDs that correspond to a connectivity entity (e.g., a router or switch). The process concludes as shown at block 524, with the log management host or management client determining, based on the comparisons performed at block 522, an end node operating condition that shares a dependency relation with one of the operational events for which one of the correlated event records was generated at block 508. For example, consider an example in which the identified end node is an automated teller machine (ATM) node and the connectivity node is a router. The end node operating condition may be a “currency cartridge empty” condition indicated as shown in FIG. 4 in association with end node 414.

FIG. 6 is a flow diagram depicting operations and functions for correlating event record data in a heterogeneous service domain monitoring environment in accordance with some embodiments. The operations and functions depicted and described with reference to FIG. 6 may be implemented by one of more of the systems, devices, and components illustrated and described with reference to FIGS. 1-4. The process begins at block 602 with two or more service domain hosts detecting and recording performance data including metrics and operational events such as faults in respective, mutually independent service domains. In some embodiments, the service domain hosts may generate event records that each include a target entity ID and a metric type from the detected performance metrics and/or operational events.

At block 604, a cross-domain log management host polls the service domain hosts and/or the association service domain logs to retrieve performance data and configuration data for target system entities within the respective service domains. In some embodiments, the log management host may compare target system configuration data across service domains to generate cross-domain configuration data (block 606). The log management host is communicatively coupled to one or more management clients as well as the service domain hosts. At block 608, a service domain host for one of the service domains supports execution of a corresponding management client. Either the service domain host or the log management host may then detect an operational event based on performance data being detected in real time (block 610). The monitoring for operational events (e.g., alarms, fault conditions, etc.) continues while the management client remains active (blocks 610 and 608).

In response to detecting a next operational event at block 610, control passes to block 612 with the service domain host or log management host (whichever detected the event) transmitting an event message containing information in one of the event records to the management client. In some embodiments, the event message contains fields that associate a first connectivity entity ID (e.g., router ID) with a network performance metric type (e.g., jitter, throughput, etc.). At block 614, the management client displays an event message object, such as one of the metric objects depicted in FIG. 3 or one of the event message objects depicted in FIG. 4. The event message object displays a target system entity ID in association with a metric type, both of which specified in the event message transmitted at block 612.

The management client may display the event message object as a selectable object within a monitoring or alarm panel window. In response to detecting an input graphical selection of the event message object (block 616), the management client generates and transmits an event correlation request to the cross-domain log management host (block 618). In some embodiments in which the event message generated at block 612 associates a first connectivity entity ID with a network performance metric type, the event correlation request specifies the first connectivity entity ID and the network performance metric type. In response to the event correlation request, the log management host accesses cross-domain configuration data to determine a network connectivity relation (block 620). The determined connectivity relation may be between the network entity corresponding to the first network entity ID and a second target system entity that may be an end node entity within a service domain external to the service domain to which the network entity belongs.

Continuing as shown at block 622, the log management host continues the correlation processing by determining whether an operational relation exists between the network performance metric type and a metric type included in another of the event records. In response to determining the operational relation, control passes to block 624 with the log management host adding the event record to a correlated event list such as that depicted in FIG. 3. All event records are correlation processed from block 620 through block 626 at which point control passes to block 628 with the log management host entering the log request phase.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

FIG. 6 depicts an example computer system that implements application log data rendering in a data processing environment in accordance with an embodiment. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes an application log rendering system 611. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for presenting analytics data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method for selectively accessing end node log data, said method comprising:
detecting operational events for target system entities that include connectivity entities and end node entities;
for each of the detected operational events, generating an event record that includes an entity identifier (ID) and a metric type;
utilizing the entity IDs and the metric types included in the event records to correlate two or more of the event records;
determining whether each of the entity IDs in the correlated event records corresponds to a connectivity entity or an end node entity; and
generating and sending log requests to each of the target system entities having an entity ID in a correlated event record that corresponds to an end node entity.

2. The method of claim 1, further comprising:
receiving log data from the target system entities to which the log requests are sent;
comparing the log data with correlated event records for target system entities having entity IDs that correspond to a connectivity entity; and
determining, based on said comparing, an end node operating condition that is causally associated with one of the operational events for which one of the correlated event records was generated.

3. The method of claim 2, further comprising a management client generating a network topology object that displayably indicates the determined end node operating condition.

4. The method of claim 3, further comprising the management client displaying the network topology object in displayable association with a displayed event message object that indicates an entity ID and a performance metric value that are included in one of the correlated event records.

5. The method of claim 1, wherein at least one of multiple service domains includes agents that each monitor and record performance metric data for one or more of a set of the target system entities, and wherein each of the event records are generated by a respective one of multiple service domain hosts, said method further comprising a first service domain host of a first service domain transmitting an event message containing information in a first of the event records to a management client.

6. The method of claim 5, wherein the event message associates a first connectivity entity ID with a network performance metric type, and wherein said correlating includes:
the management client generating and transmitting to an inter-domain log management host, an event correlation request that specifies the first connectivity entity ID and the network performance metric type; and
in response to the event correlation request, the inter-domain log management host accessing cross-domain configuration information to determine a network connectivity relation between a first connectivity entity corresponding to the first connectivity entity ID and a second target system entity within a second service domain, wherein the second target system entity corresponds to an entity ID included in a second of the event records.

7. The method of claim 6, wherein said correlating further includes determining an operational relation between the network performance metric type and a metric type included in the second event record.

8. The method of claim 6, wherein the management client generates the event correlation request in response to graphical input selection of a displayed metric object that includes the first connectivity entity ID and a network performance metric.

9. The method of claim 1, further comprising:
monitoring performance metric data for target system entities that include connectivity entities and end node entities; and
detecting operational events associated with the performance metric data.

10. The method of claim 1, further comprising, in response to determining that the entity IDs in the correlated event records correspond to a connectivity entity, retrieving performance metrics of one or more of the target system entities that correspond to the entity IDs.

11. One or more non-transitory machine-readable storage media comprising program code for selectively accessing end node log data, the program code to:
detect operational events for target system entities that include connectivity entities and end node entities;
for each of the detected operational events, generate an event record that includes an entity identifier (ID) and a metric type;
utilize the entity IDs and the metric types included in the event records to correlate two or more of the event records;
determine whether each of the entity IDs in the correlated event records corresponds to a connectivity entity or an end node entity; and
generate and send log requests to each of the target system entities having an entity ID in a correlated event record that corresponds to an end node entity.

12. The machine-readable storage media of claim 11, wherein the program code further includes program code to:
receive log data from the target system entities to which the log requests are sent;
compare the log data with correlated event records for target system entities having entity IDs that correspond to a connectivity entity; and
determine, based on said comparing, an end node operating condition that is causally associated with one of the operational events for which one of the correlated event records was generated.

13. The machine-readable storage media of claim 12, wherein the program code further includes program code of a management client to generate a network topology object that displayably indicates the determined end node operating condition.

14. The machine-readable storage media of claim 11, wherein at least one of multiple service domains includes agents that each monitor and record performance metric data for one or more of a set of the target system entities, and wherein each of the event records are generated by a respective one of multiple service domain hosts, the program code further including program code of a first service domain host of a first service domain to transmit an event message containing information in a first of the event records to a management client.

15. The machine-readable storage media of claim 14, wherein the event message associates a first connectivity entity ID with a network performance metric type, and wherein the program code to correlate includes:
program code of the management client to generate and transmit to an inter-domain log management host, an event correlation request that specifies the first connectivity entity ID and the network performance metric type; and
program code of the inter-domain log management host to, in response to the event correlation request, access cross-domain configuration information to determine a network connectivity relation between a first connectivity entity corresponding to the first connectivity entity ID and a second target system entity within a second service domain, wherein the second target system entity corresponds to an entity ID included in a second of the event records.

16. The machine-readable storage media of claim 14, wherein the program code further includes program code of the management client to generate the event correlation request in response to graphical input selection of a displayed metric object that includes the first connectivity entity ID and a network performance metric.

17. An apparatus comprising:
a processor; and
a machine-readable medium having program code executable by the processor to cause the apparatus to,
detect operational events for target system entities that include connectivity entities and end node entities;
for each of the detected operational events, generate an event record that includes an entity identifier (ID) and a metric type;
utilize the entity IDs and the metric types included in the event records to correlate two or more of the event records;
determine whether each of the entity IDs in the correlated event records corresponds to a connectivity entity or an end node entity; and
generate and send log requests to each of the target system entities having an entity ID in a correlated event record that corresponds to an end node entity.

18. The apparatus of claim 17, wherein the program code further includes program code executable by the processor to cause the apparatus to:
receive log data from the target system entities to which the log requests are sent;
compare the log data with correlated event records for target system entities having entity IDs that correspond to a connectivity entity; and
determine, based on said comparing, an end node operating condition that is causally associated with one of the operational events for which one of the correlated event records was generated.

19. The apparatus of claim 18, wherein the program code further includes program code executable by the processor to cause the apparatus to generate a network topology object that displayably indicates the determined end node operating condition.

20. The apparatus of claim 17, wherein at least one of multiple service domains includes agents that each monitor and record performance metric data for one or more of a set of the target system entities, and wherein each of the event records are generated by a respective one of multiple service domain hosts, the program code further including program code of a first service domain host of a first service domain to transmit an event message containing information in a first of the event records to a management client, wherein the event message associates a first connectivity entity ID with a network performance metric type, and wherein the program code executable by the processor to cause the apparatus to correlate includes:
program code of the management client to generate and transmit to an inter-domain log management host, an event correlation request that specifies the first connectivity entity ID and the network performance metric type; and
program code of the inter-domain log management host to, in response to the event correlation request, access cross-domain configuration information to determine a network connectivity relation between a first connectivity entity corresponding to the first connectivity entity ID and a second target system entity within a second service domain, wherein the second target system entity corresponds to an entity ID included in a second of the event records.
